(19) United States
(12) Patent Application Publication
(10) Pub. No.: US 2016/0082464 A1
(43) Pub. Date: Mar. 24, 2016

(54) INSULATED SUPPORT TOOL

(71) Applicant: AKEBONO BRAKE INDUSTRY CO., LTD., Tokyo (JP)

(72) Inventors: Tomomasa Osawa, Tokyo (JP); Yukio Iwata, Tokyo (JP); Jungo Masuda, Tokyo (JP); Yuya Niwano, Tokyo (JP)

(21) Appl. No.: 14/888,464

(22) PCT Filed: Nov. 26, 2014
(86) PCT No.: PCT/JP2014/005916

§ 371 Date: Nov. 2, 2015

(30) Foreign Application Priority Data
Nov. 26, 2013 (JP) 2013-244106

(51) Int. Cl. B05B 15/04; B05D 1/12; F16D 65/00; B05B 5/08

(52) U.S. Cl. CPC B05B 15/0431; B05B 5/082; B05D 1/12; F16D 65/0068

(57) ABSTRACT

To provide an art that can perform masking more easily than in the prior art. A support tool that is used in a powder coating system that electrostatically attaches powder to a workpiece, and supports the workpiece, wherein in the support tool, a region that is in contact with a part of a region not needing powder in the workpiece is formed of an insulator, and restrains adhesion of the powder to the part of the region not needing powder in the workpiece.

### TECHNICAL FIELD

The present invention relates to a support tool, a powder coating system, a powder coating method and a caliper.

### BACKGROUND ART

Coating is applied to industrial products for the purpose of rust prevention, decoration and the like. Regions not needing coating are present in industrial products, and masking is applied to the regions not needing coating so that coating materials do not adhere to the regions not needing coating. As the conventional masking method, there is the art which attaches a tape and a cap for masking to a region not needing coating, and detaches the tape and the cap for masking after coating. Further, for example, Patent Document 1 discloses an art of sucking a powder coating material on inner circumferential surfaces of a hub hole and a bolt hole of a wheel of a center cap type. Further, Patent Document 2 discloses a masking device that performs masking for a component to be coated by ejection of pressure air at the time of coating by a spray gun. The masking device described in Patent Document 2 ejects the pressure air that is regulated to a desired pressure to portions needing masking in the component to be coated through an air supply conduit, a rotary joint, a channel in a spindle and an inside of a work sheet, during an operation of the spray gun. Further, Patent Document 3 discloses a coating support device that supports a hollow object to be coated having a plurality of opening portions. The coating support device described in Patent Document 3 includes a fitting support portion which is a fitting support portion that supports an object to be coated by being fitted in one opening portion of a plurality of opening portions, and includes an air path in an inside, and air supply means that supplies air to a hollow portion of the object to be coated via the air path when or after a coating material is attached to the object to be coated.

### CITATION LIST

### Patent Literature

Japanese Patent Laid-Open No. 2002-346464

Japanese Utility Model Laid-Open No. 5-67361

Japanese Patent Laid-Open No. 2009-233510

### SUMMARY OF INVENTION

In the conventional method of masking which attaches a tape and a cap for masking to a region not needing coating, and detaches the tape and the cap for masking after coating, attaching and detaching a tape and a cap for masking are needed. Therefore, an operation of masking is complicated, and it is feared that a coating film on the object to be coated and coating films which adhere to the tape and the cap for masking are integrated, and when the tape and the cap for masking are detached, the coating film on the object to be coated easily peels off.

The present invention is made in the light of the above described problem, and has a problem to provide an art of being able to perform masking more easily than the prior art.

In the present invention, in order to solve the above described problem, with respect to a support tool that supports a workpiece, a region that is in contact with a part of a region not needing powder in the workpiece is configured by an insulator, and restrains adhesion of the powder to the part of the region not needing powder in the workpiece.

In more detail, the present invention is a support tool that is used in a powder coating system that electrostatically attaches powder to the workpiece, is fixed to a robot arm, and supports the workpiece, wherein in the support tool, a region that is in contact with a part of a region not needing powder in the workpiece is formed of an insulator, and restrains adhesion of the powder to the part of the region not needing powder in the workpiece.

In the present invention, of the support tool which is fixed to the robot arm, the region which is in contact with a part of the region not needing powder in the workpiece is configured by an insulator, whereby adhesion of powder to the part of the region not needing powder in the workpiece can be restrained. As a result, masking can be performed more easily than in the prior art.

The workpiece includes an opening portion, and a recessed portion that communicates with the opening portion, and the support tool may support the recessed portion of the workpiece from inside and include an air passage in which air flows, in an inside. The workpiece includes the recessed portion, whereby the support tool utilizes a shape of the workpiece, and can support the recessed portion of the workpiece from inside. Further, the recessed portion and the opening portion of the workpiece communicate with each other, and therefore, by ejecting air via the air passage of the support tool, the powder adhering to the inner surface of the opening portion can be removed from inside of the workpiece by a positive pressure.

The support tool may include a fitting portion that is fitted in a part of the recessed portion of the workpiece in an airtight state, the fitting portion may be configured by a conductive member and electrically grounded, and powder may be electrically attached to the workpiece in an electrically grounded state. In the support tool according to the present invention, the support tool can easily grasp the workpiece, and in the art of electrostatically attaching powder, the powder on the region not needing powder can be easily removed.

The support tool may include an inclined portion that makes a thickness of the powder which adheres to the workpiece gradually thinner toward the region not needing powder, at an edge portion of a surface that is in contact with the workpiece. Thereby, a difference between a film thickness of the powder adhering region where powder adheres, and a film thickness of the region not needing powder can be gradually decreased. In other words, the film thickness can be gradually made thinner toward the region not needing powder from the powder adhering region. As a result, a powder film by powder hardly peels off.

The workpiece includes a dent portion that is further dented from the recessed portion, in the recessed portion of the workpiece, and the support tool may include a protrudingly provided portion that enters the dent portion, and includes an outlet port that ejects air that restrains adhesion of the powder to an inner surface of the dent portion. Thereby, adhesion of the powder to the inner surface of the dent portion can be restrained.

Further, the workpiece is a caliper for a brake, a cylinder is provided in a part of the recessed portion of the workpiece, a part of the region not needing powder is a pad clip mounting portion in a recessed shape and a torque receiving portion, and the support tool may include a protrudingly provided portion that enters the pad clip mounting portion in the recessed shape, and includes an outlet port that ejects air that restrains adhesion of powder to an inner surface of the pad clip mounting portion in the recessed shape. Thereby, adhesion of the powder to the inner surface of the pad clip mounting portion in the recessed shape can be restrained.

Here, the present invention can be specified as a powder coating system including the aforementioned support tool. Namely, the present invention is a powder coating system that electrostatically attaches powder to a workpiece, and is a powder coating system that includes a support tool that supports the workpiece, and a movable robot arm to which the support tool is fixed, wherein in the support tool, a region that is in contact with a part of a region not needing powder of the workpiece is formed of an insulator, and restrains adhesion of the powder to the part of the region not needing powder of the workpiece.

In the present invention, the workpiece is supported by the support tool which is fixed to the movable robot arm, whereby the workpiece can be freely moved. Therefore, the workpiece can be coated while the workpiece is being supported by the support tool which is fixed to the robot arm. Further, of the support tool, the region that is in contact with a part of the region not needing powder in the workpiece is configured by an insulator, whereby adhesion of powder to the part of the region not needing powder in the workpiece can be restrained. As a result, masking can be performed more easily than the prior art.

Further, the powder coating system according to the present invention may further include a removing device that restrains adhesion of powder to the region not needing powder in the workpiece which is supported by the support tool at a tip end portion of the robot arm, or removes powder that adheres to a powder adhering region, by at least either one of ejection or suction. According to the present invention, while the workpiece is being supported by the support tool which is fixed to the robot arm, adhesion of the powder to the region not needing powder in the supported workpiece is restrained, or the powder which adheres to the powder adhering region can be removed.

Here, the removing device may include at least any one of a first ejection device that restrains adhesion of powder to the region not needing powder, by ejection of air, a second ejection device that removes powder adhering to the region not needing powder, by ejection of air, and a suction device that removes the powder adhering to the region not needing powder, by suction. Thereby, restraint of adhesion of the powder to the region not needing powder, or removal of the powder adhering to the region not needing powder can be performed by a negative pressure or a positive pressure.

Further, the removing device includes the first ejection device that restrains adhesion of the powder to the region not needing powder, by ejection of air, the workpiece includes an opening portion, and a recessed portion that communicates with the opening portion, the support tool supports the recessed portion of the workpiece from inside, and includes an air passage in which air flows, in an inside, and the first ejection device may eject air via the air passage of the support tool, and may restrain adhesion of powder to an inner surface of the opening portion, from inside of the workpiece.

The workpiece includes the recessed portion, whereby the support tool utilizes the shape of the workpiece, and can support the recessed portion of the workpiece from inside. Further, the recessed portion and the opening portion of the workpiece communicate with each other, and therefore, by ejecting air via the air passage in the support tool, adhesion of the powder to the inner surface of the opening portion can be restrained from inside of the workpiece, by a positive pressure.

Further, the support tool may include a fitting portion that is fitted in a part of the recessed portion of the workpiece in an airtight state, the fitting portion may be configured by a conductive member, and may be electrically grounded, and powder may be electrostatically attached to the workpiece in an electrically grounded state. In the powder coating system according to the present invention, the support tool can easily grasp the workpiece, and in the art of electrostatically attaching powder, adhesion of the powder to the region not needing powder can be restrained.

The workpiece is a caliper for a brake, a cylinder is provided in a part of the recessed portion of the workpiece, and a part of the region not needing powder may be a pad clip mounting portion and a torque receiving portion. The cylinders may be disposed to face each other, and or may be disposed at one side. The powder coating system according to the present invention can be favorably used in powder coating for the caliper body of a caliper for a brake, as one example.

Here, the robot can be made a robot capable of freely moving the workpiece three-dimensionally. As a result, coating can be performed while the workpiece is fixed to the robot, and further, restraint of adhesion of the powder to the region not needing powder, and removal of the powder on the region not needing powder can be performed while the workpiece is kept fixed to the robot. Further, since the workpiece itself is three-dimensionally movable, redoing of workpiece fixation (redoing of support) and disposition of removing devices such as a plurality of suction devices and ejection devices around the workpiece are not needed. Therefore, removal of the powder on the region not needing powder can be performed more easily than in the prior art. Further, according to the powder coating system according to the present invention, three-dimensional movement of the workpiece is freely performed, and therefore, the difference between the film thickness of the powder adhering region and the film thickness of the region not needing powder can be gradually decreased. In other words, the film thickness can be gradually made thinner toward the region not needing powder from the powder adhering region.

Further, the powder coating system according to the present invention is a powder coating device that attaches powder to the workpiece, may further include a powder coating device having the ejection device and the suction device, and a heating device that bakes the powder adhering to the workpiece to the workpiece, wherein the powder coating device and the heating device may be disposed in a movable range of the robot. The powder coating device and the heating device are disposed in the movable range of the robot, whereby powder coating can be performed more efficiently. Further, the ejection device and the suction device are provided in the powder coating device, and removal of the powder on the region not needing powder by suction and ejection also can be performed efficiently.

Further, the present invention also can be specified as a powder coating method. Namely, the present invention is a powder coating method that electrostatically attaches powder to a workpiece, and includes the step of supporting the workpiece by a support tool that is fixed to a grasping portion at a tip end portion of a movable robot arm, and restraining adhesion of powder to a part of a region not needing powder of the workpiece, by making a region that is in contact with the part of the region not needing powder of the workpiece, of the support tool, an insulator. The powder coating method according to the present invention may include a powder removing step of supporting the workpiece by the support tool fixed to the three-dimensionally freely movable robot, and removing powder by sucking the powder on the region not needing powder of the workpiece fixed to the robot with a suction nozzle, after the powder adheres to the workpiece. Further, the powder coating method according to the present invention may further include a powder removing step of restraining adhesion of powder to the region not needing powder in the workpiece supported by the support tool at the tip end portion of the robot arm, or removing the powder adhering to the powder adhering region, by at least either one of ejection or suction.

The powder coating method according to the present invention includes a powder coating step of attaching powder to the workpiece, and a heating step heating the workpiece to which the powder adheres, and the powder removing step includes a step of removing the powder on the region not needing coating by ejection of air when the powder adheres to the workpiece, wherein the powder coating step, the powder removing step and the heating step may be performed in a state in which the workpiece is fixed to the robot via the support tool, by moving the robot three-dimensionally.

Further, the present invention can be also specified as a production method of a caliper. For example, the present invention includes a step of supporting the workpiece by the support tool which is fixed to the freely movable robot and supports the workpiece, and restraining adhesion of powder to a part of the region not needing powder in the workpiece by making the region that is in contact with the part of the region not needing powder in the workpiece, of the support tool, an insulator, a powder coating step of attaching powder to the caliper, a powder removing step of sucking powder on the region not needing powder of the caliper supported by the support tool, with a suction nozzle, a heating step of baking the powder adhering to the caliper to the workpiece, and a cooling step of cooling the caliper to which the powder is baked so as to be able to transfer the caliper to a next step (for example, assembly or the like).

Further, the present invention also can be specified as a caliper. For example, the present invention is a caliper that is produced by the aforementioned powder coating system.

Further, the caliper may be formed so that a film thickness is gradually thinner toward a region not needing powder from a powder adhering region. Thereby, occurrence of coating removal or the like that is feared in the conventional masking by a plug and a tape can be restrained.

According to the present invention, masking can be performed more easily than in the prior art.

### BRIEF DESCRIPTION OF DRAWINGS

FIG. 1 illustrates a view of a caliper body according to an embodiment, seen from an outside diameter side of a rotor.

FIG. 2 illustrates a view of the caliper body according to the embodiment, seen from an axial side of the rotor.

FIG. 3 illustrates a view of the caliper body according to the embodiment, seen from outside.

FIG. 4 illustrates a side view of the caliper body according to the embodiment.

FIG. 5 illustrates the caliper body according to the embodiment, seen from inside.

FIG. 6 illustrates a sectional view taken along A-A line in FIG. 4 of the caliper body according to the embodiment.

FIG. 7 illustrates a schematic configuration of a powder coating system according to the embodiment.

FIG. 8 illustrates a side view of a robot according to the embodiment.

FIG. 9 illustrates an enlarged view of a tip end portion of a robot arm according to the embodiment.

FIG. 10 illustrates a state in which a powder coating auxiliary tool is fixed to the tip end portion of the robot arm according to the embodiment.

FIG. 11 illustrates a surface on an outer side of the powder coating auxiliary tool according to the embodiment.

FIG. 12 illustrates a surface on an inner side of the powder coating auxiliary tool according to the embodiment.

FIG. 13A illustrates a sectional view in a position along line A-A in FIG. 4 in a case in which the powder coating auxiliary tool is connected to the caliper body according to the embodiment.

FIG. 13B illustrates a sectional view seen from a rotor axis side in a position along line B-B in FIG. 3 in the case in which the powder coating auxiliary tool is connected to the caliper body according to the embodiment.

FIG. 14 illustrates a coating device according to the embodiment.

FIG. 15 illustrates a coating treatment flow according to the embodiment.

FIG. 16 illustrates a sectional view of a vicinity of a boundary of a coated region and a region not needing coating.

FIG. 17 illustrates a manner of grasping a motor case as an industrial product.

### DESCRIPTION OF EMBODIMENTS

Next, an embodiment of the present invention will be described based on the drawings. In the embodiment, a case of using a powder coating system of the present invention in electrostatic coating of a caliper body of a disk brake of an automobile will be described as an example. However, a matter that will be described hereinafter is an illustration, and the present invention is not limited to a content of the embodiment which will be described hereinafter.

### Embodiment

### Caliper

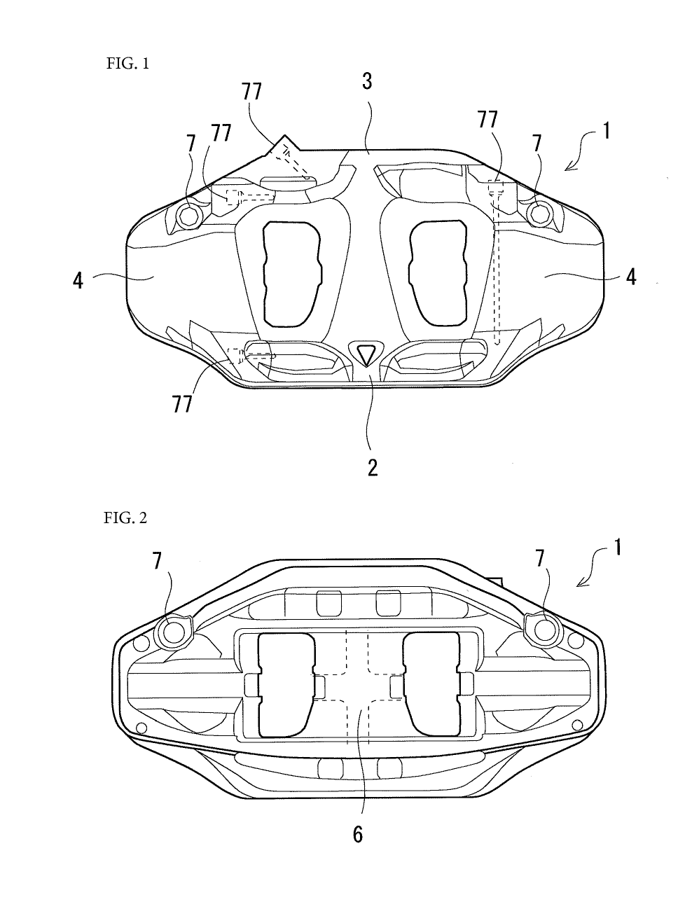

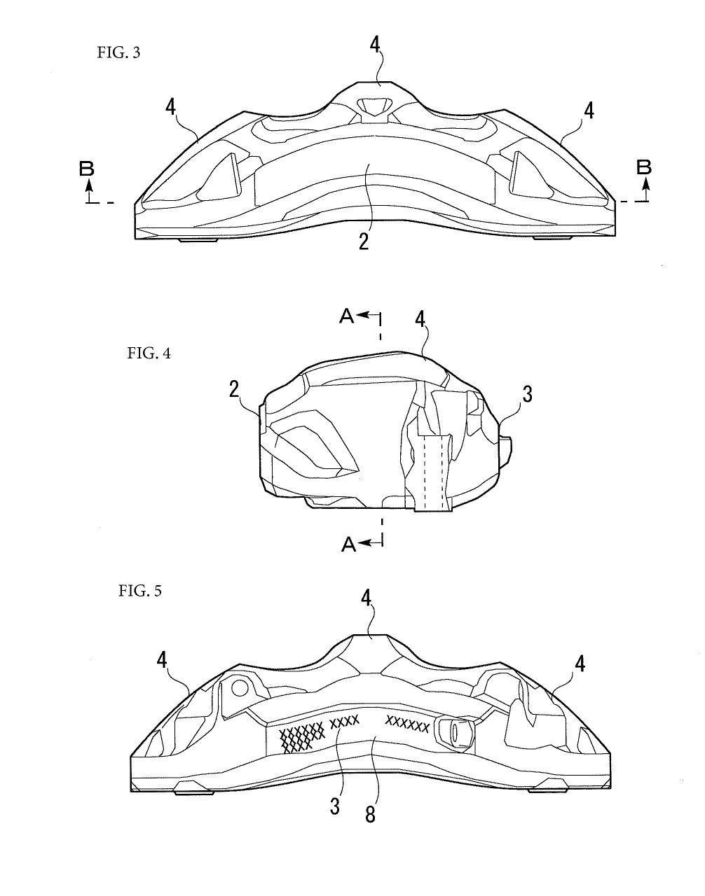

To begin with, a caliper body 1 (hereinafter, also simply called a caliper 1) of a disk brake of an automobile that is electrostatically coated will be described. FIG. 1 to FIG. 6 illustrate a caliper according to the embodiment. The caliper 1 (corresponding to a workpiece of the present invention) is to be used in an opposed piston type disk brake, and is an aluminum caliper integrally formed from an aluminum alloy. The caliper 1 includes a recessed portion 6 that accommodates a disk rotor which rotates with a wheel (Not illustrated. Hereinafter, also simply called a rotor), and a brake pad (not illustrated), and is widely opened. The caliper 1 is made by integrally forming a first body portion 2 and a second body portion 3 that are disposed at both sides (an outer side and an inner side) in an axial direction of the rotor, and a connecting portion 4 that connects both the body portions 2 and 3. In a first embodiment, six cylinders 5 in total are provided in the entire caliper 1, three for each of the first body portion 2 and the second body portion 3. The three cylinders 5 at the first body portion 2 side communicate with one another inside, and the three cylinders 5 at the second body portion 3 side also communicate with one another inside. Pistons (not illustrated) are respectively fitted into the respective cylinders 5, in an assembled state of the disk brake.

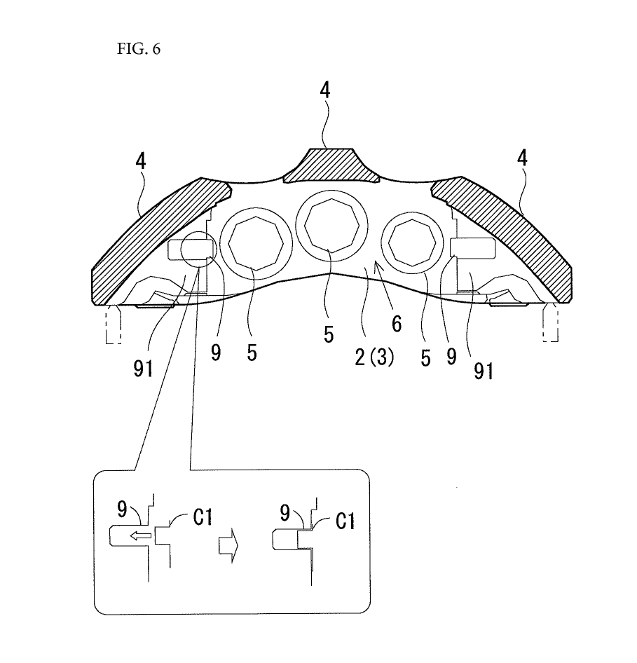

As illustrated in FIG. 1 and FIG. 2, mounting holes 7 for fixing the caliper 1 to a vehicle are provided in a close vicinity to both end portions of the second body portion 3. Further, the first body portion 2 and the second body portion 3 are provided with a plurality of sealable supply holes 77 that communicate with the cylinders 5 and supply oil to the cylinders 5. Further, as illustrated in FIG. 5, the second body portion 3 is provided with a printed surface 8 on which information for management (for example, a QR code for production management (registered trademark), a barcode, a serial number and the like) is printed. Further, as illustrated in FIG. 6, in an inner side surface of the recessed portion 6, at the connecting portion 4 sides (sides of ear portions (not illustrated) of the brake pads which are fixed to the caliper 1), of inner side surfaces of the first body portion 2 and the second body portion 3, torque receiving portions 91 that support brake pads are provided. Further, the torque receiving portion 91 is provided with a clip mounting portion 9 (one example of a dent portion of the present invention) in a recessed shape to which a pad clip C1 (see an enlarged view in FIG. 6) that is connected to the ear portion of the brake pad, and fixes the brake pad to the caliper 1 is fixed. The mounting holes 7, the printed surface 8, the torque receiving portions 91 and the clip mounting portions 9, and the supply holes 77 described above are spots not needing electrostatic coating (corresponding to a region not needing powder of the present invention), where adhesion of a powder coating material is restrained, or the adhering powder coating material is removed, by a suction device 50 or an ejection device 60 that is provided in a coating device 10, when electrostatic coating is performed with the coating device 10. An effect of restraining adhesion of the powder coating material, or removing the adhering powder coating material is an effect that surpasses the conventional masking with a tape and a cap. The supply hole 77 is one example of an opening portion of the present invention. Note that a basic structure of the caliper 1 is similar to the caliper that is conventionally known, and therefore, detailed explanation will be omitted.

<<Configuration of Powder Coating System>>

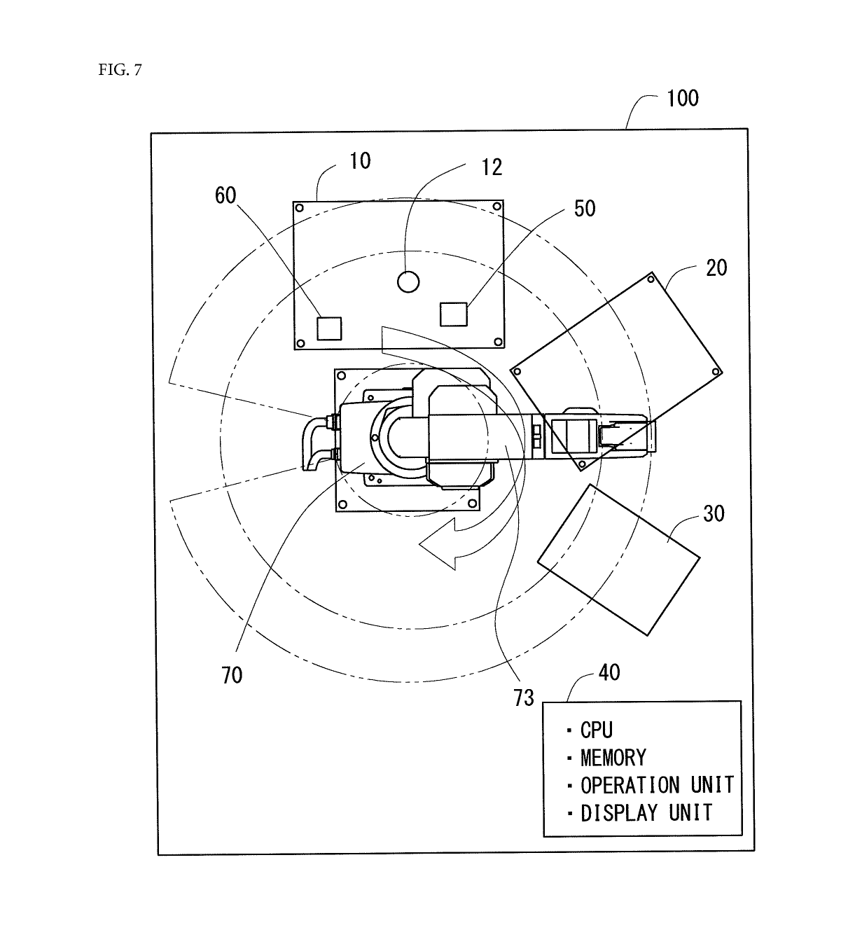

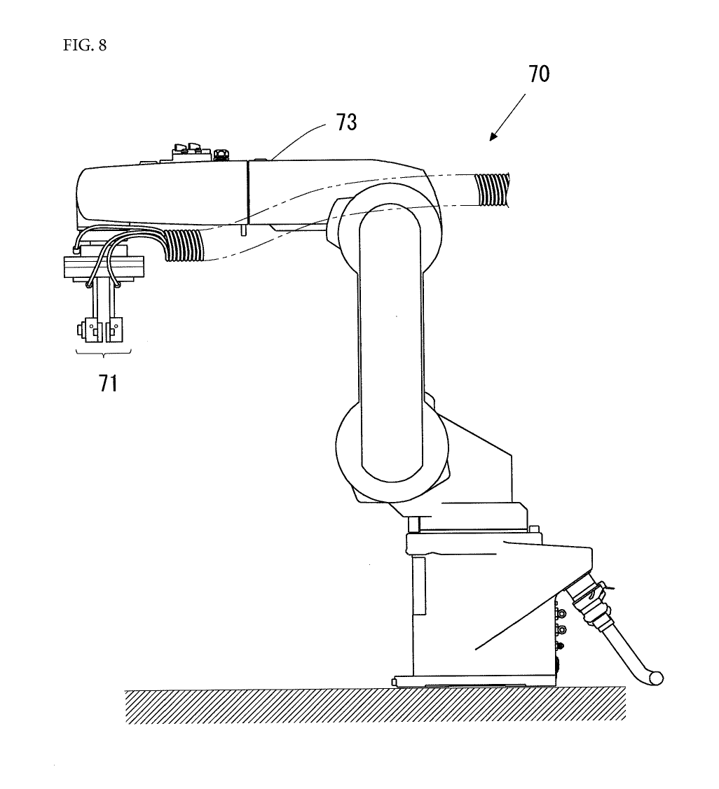

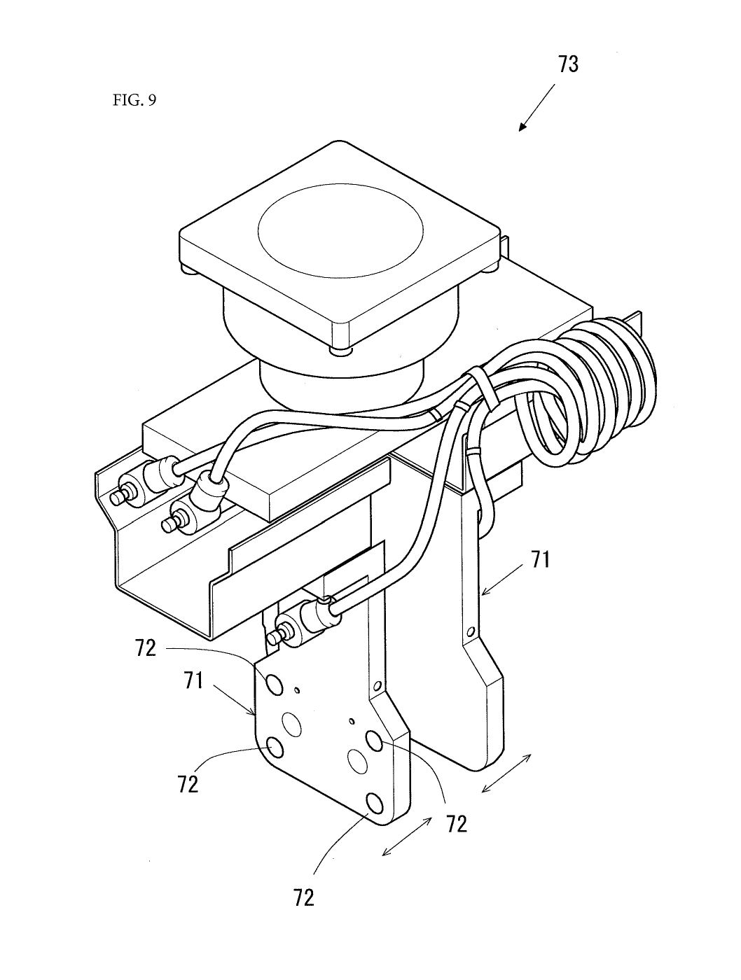

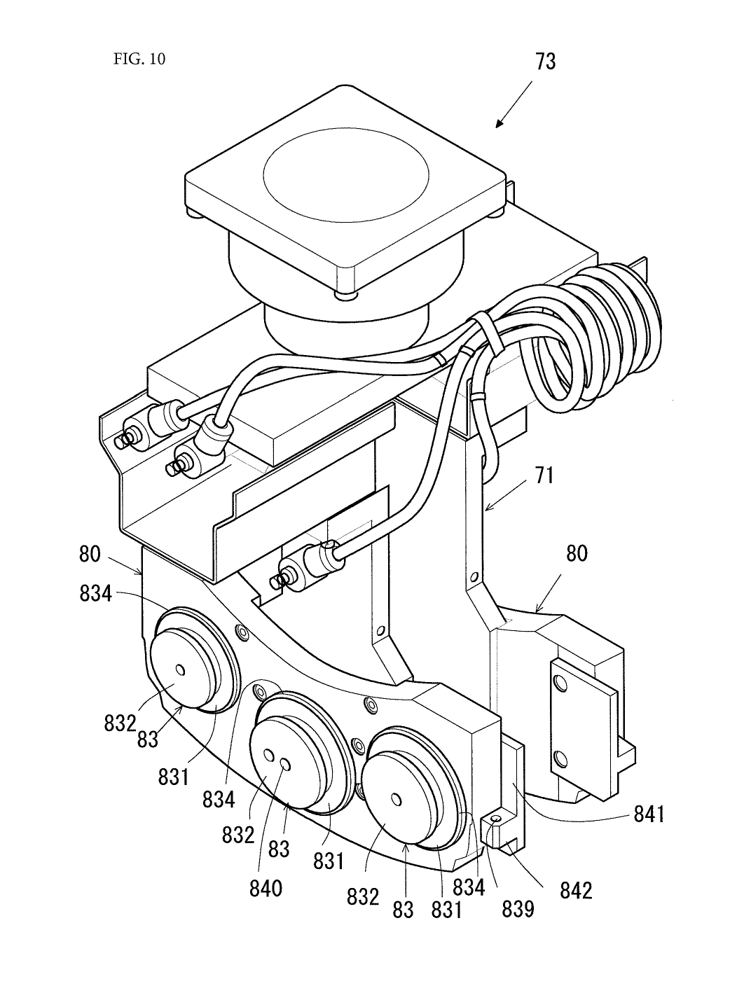

As illustrated in FIG. 7, a powder coating system 100 according to the embodiment (corresponding to a powder coating system of the present invention) includes a robot 70, the coating device 10, a heating device 20, a cooling device 30 and a control device 40. A powder coating auxiliary tool 80 (see FIG. 10) is attachable to a tip end portion of a robot arm 73 of the robot 70. Further, the coating device 10 is provided with the suction device 50 and the ejection device 60.

The robot 70 grasps the caliper body 1, and is movable three-dimensionally. The robot 70 according to the embodiment is an industrial machine that operates according to a teaching playback method, and is a so-called six-axis vertical articulated robot. The robot 70 preferably has six axes which has a high degree of freedom, but may have five axes or four axes. The robot 70 is automatically controlled by a CPU reading a program that is stored in a memory in advance. More specifically, the robot 70 performs grasp of the caliper 1, locomotion between devices (for example, locomotion to the heating device 20 from the coating device 10), change of an attitude of the caliper 1 in the respective devices, and the like.

Here, FIG. 9 illustrates an enlarged view of the tip end portion of the robot arm 73 according to the embodiment. At the tip end portion of the robot arm 73, plate-shaped opposing grasping portions 71 are provided. The grasping portions 71 are movable in a direction perpendicular to the opposing surfaces, which is illustrated by the arrows in FIG. 9. In other words, the grasping portions 71 can freely change a distance from each other in a state in which the opposing surfaces are parallel with each other. Further, the grasping portion 71 is provided with a plurality of auxiliary tool fixing holes 72 that fix the powder coating auxiliary tool 80 (corresponding to a support tool of the present invention) which grasps the caliper 1. The auxiliary tool fixing holes 72 can be connected to the powder coating auxiliary tool 80 by burying magnets inside. For fixation of the powder coating auxiliary tool 80 to the grasping portion 71, other fixing methods that can freely detach the grasping portion 71 and the powder coating auxiliary tool 80, such as screwing, vacuum suction and clamps may be adopted. Further, an air supply path (not illustrated) that supplies air is provided in the grasping portion 71, and supply of air to the powder coating auxiliary tool 80 is enabled.

FIG. 10 illustrates a state in which the powder coating auxiliary tool 80 is fixed to the tip end portion of the robot arm 73 according to the embodiment. As illustrated in FIG. 10, the powder coating auxiliary tools 80 which grasp the caliper body 1 are fixed to surfaces (surfaces on sides opposite to the opposing surfaces) on outer sides of the grasping portions 71 at a tip end of the arm of the robot 70.

<<Powder Coating Auxiliary Tool>>

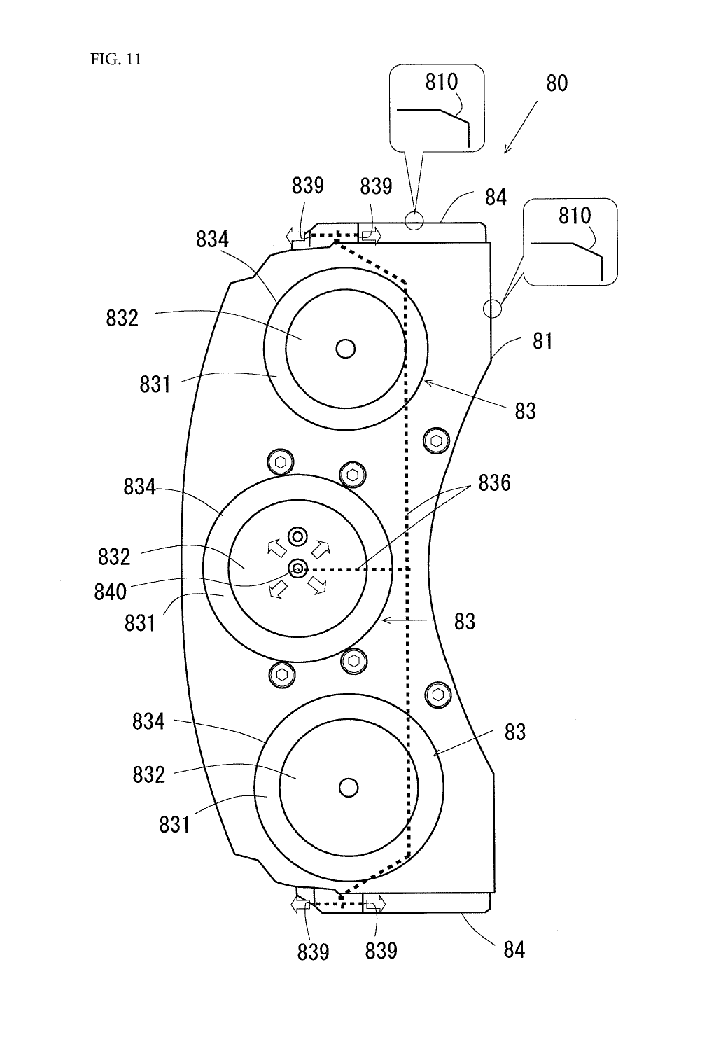

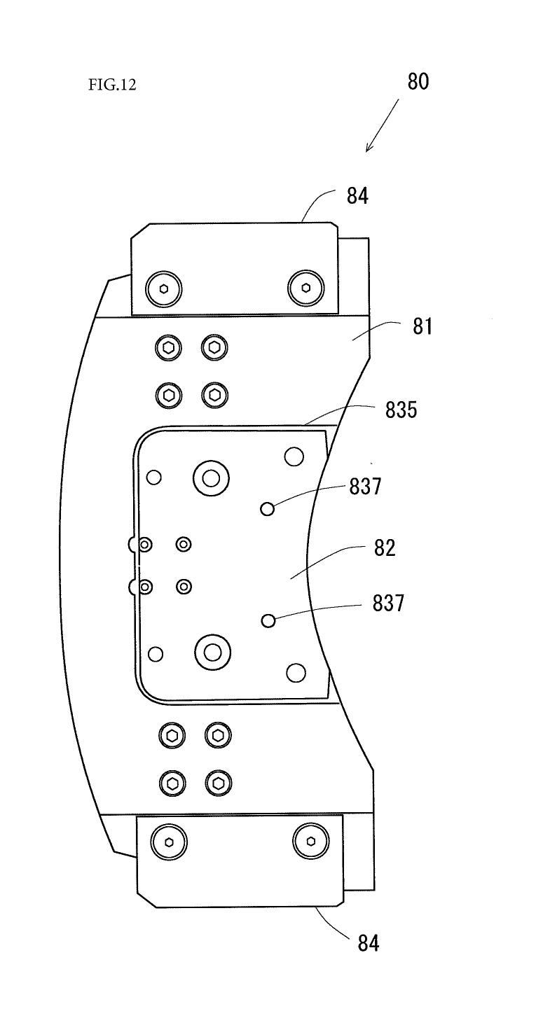

FIG. 11 illustrates a surface (a surface on a side in contact with the inner surface of the recessed portion 6 of the caliper 1) on an outer side of the powder coating auxiliary tool 80 according to the embodiment. FIG. 12 illustrates a surface on an inner side of the powder coating auxiliary tool according to the embodiment. The powder coating auxiliary tool 80 includes a main body portion 81 of an insulator in a slender plate shape, and a plate-shaped conducting portion 82 (see FIG. 12) that is fixed to an inner side surface of the main body portion 81. The powder coating auxiliary tool 80 is accommodated in the recessed portion 6 of the caliper 1, and therefore, is designed in accordance with a shape of the recessed portion 6. On a surface on an outer side of the main body portion 81, three circular protruded portions 83 that are fitted in the cylinders 5 of the caliper 1 are provided. The protruded portion 83 includes a large diameter portion 831 that is further protruded from an outer side surface of the main body portion 81, and a small diameter portion 832 that includes a diameter smaller than the large diameter portion 831 and is further protruded from the large diameter portion 831. An O-ring 834 that restrains entry of a powder coating material into the cylinder 5 is connected to an outer periphery of the large diameter portion 831. The small diameter portion 832 includes a circumferential edge formed into a taper shape in accordance with a shape of the cylinder 5. As illustrated in an enlarged view in FIG. 11, an inclined portion 810 of the main body portion may be formed at an edge of an outer side surface of the main body portion 81. The inclined portion 810 of the main body portion may be formed at a whole of the edge of the outer side surface of the main body portion 81, or may be formed at a part of the edge.

On the surface on the inner side of the main body portion 81, an accommodation portion 835 that accommodates the plate-shaped conducting portion 82 is provided. In the present embodiment, the protruded portion 83 which is located in a center, and the conducting portion 82 electrically continue to each other in the main body portion 81. Further, the grasping portion 71 of the robot 70 to which the conducting portion 82 is fixed is configured of steel, and functions as a ground. Accordingly, an electrified powder coating material is injected with the caliper 1 being grasped by the grasping portions 71 via the powder coating auxiliary tools 80, whereby the entire caliper 1 can be electrostatically coated. Further, the main body portion 81 is configured of a resin and is non-conductive, and therefore can restrain unneeded adhesion of the coating material. Further, the inclined portion 810 of the main body portion is formed at the edge of the outer side surface of the main body portion 81, whereby when the powder coating material is injected in a state in which the powder coating auxiliary tool 80 is accommodated in the recessed portion 6 of the caliper 1, the powder coating material advances into a gap that is formed between the inclined portion 810 of the main body portion and the inner surface of the recessed portion 6. Therefore, a film thickness of the powder coating material which adheres to the inner surface of the recessed portion 6 of the caliper 1 can be gradually formed to be thinner toward a region in contact with the main body portion 81. Note that the protruded portions 83 other than the protruded portion 83 which is located in a center, and the conducting portion 82 may be electrically continued to each other in the main body portion 81. Note that the powder coating auxiliary tool 80 can be adapted to calipers of various kinds and specifications by changing positions and sizes of the protruded portions 83.

Inside the powder coating auxiliary tool 80, an air passage 836 in which air passes (illustrated by the dotted lines in FIG. 11, and the arrows written in close proximity to end portions of the dotted lines indicate flows of air). In more detail, inlet ports 837 of the air passage are provided at two spots in a vicinity of a center of a long side of the main body portion 81 that is located at a base portion side of the grasping portion 71, at the inner side of the main body portion 81, as positions corresponding to outlet ports (not illustrated) of the air supply passage provided in the grasping portion 71 (see FIG. 12). The air passage 836 extends in a longitudinal direction to pass through the two inlet ports 837 in the main body portion 81, branches in a center, and extends in a short side direction to a central outlet port 840 provided in a center of the central protruded portion 83. Air that is ejected from the central outlet port 840 provided in the central protruded portion 83 passes through the other protruded portions 83 which communicate inside the caliper 1, and the supply holes 77 which communicate inside the caliper 1. As a result, at the time of coating, adhesion of the powder coating material to the inner side surfaces of all the cylinders 5, the supply holes 77, communication holes that cause the cylinders 5 to communicate with one another, and communication holes that cause the cylinders 5 and the supply holes 77 to communicate with one another is restrained. In this manner, the powder coating auxiliary tools 80 grasp the caliper 1, and also have a function of restraining adhesion of the powder coating material.

To both sides in the longitudinal direction of the main body portion 81, cover members 84 of an insulator that retrains adhesion of powder to the clip mounting portion 9 in the recessed shape of the caliper 1 are connected. Outlet ports of the air passage 836 which extends in the longitudinal direction are respectively provided at both sides in the longitudinal direction of the main body portion 81. The air passage 836 extending in the longitudinal direction extends to the cover members 84. The cover member 84 includes a plate-shaped base portion 841 that is connected to the inner side surface of the main body portion 81, and a protrudingly provided portion 842 that is orthogonal to both the side surfaces of the main body portion 81. The cover member 84 is also configured from a resin that is an insulator similarly to the main body portion 81. The air passage 836 which extends to the cover members 84 passes through the protrudingly provided portions 842, and extends to respective outlet ports 839 that are provided in opposing side surfaces (side surfaces in the short side direction of the main body portion 81) of the cover member 84. Air that is ejected from the respective outlet ports 839 restrains adhesion of the powder coating material to the inner side of the clip mounting portion 9 in the recessed shape. In a close vicinity to the respective outlet ports 839, in other words, in a vicinity of an inlet port of the clip mounting portion 9 in the recessed shape, adhesion of the powder coating material is restrained the most effectively. Meanwhile, the more away from the respective outlet ports 839, in other words, toward a back side of the clip mounting portion 9 in the recessed shape, the effect of restraining adhesion of the powder coating material becomes weaker. Therefore, a film thickness of the powder coating material which adheres to the inner surface of the clip mounting portion 9 in the recessed shape gradually becomes thinner toward the inlet port side from the back side (see FIG. 16). As a result, the powder coating material which adheres to the inner surface of the clip mounting portion 9 in the recessed shape also becomes difficult to peel off.

As illustrated in an enlarged view in FIG. 11, an inclined portion 840 of the cover member may be formed at an edge of an outer side surface of the cover member 84 of an insulator. The inclined portion 840 of the cover member may be formed at a whole of the edge of the outer side surface of the cover member 84, or may be formed at a part of the edge. By forming the inclined portion 840 of the cover member, the powder coating material advances into a gap that is formed between the inclined portion 840 of the cover member and an exposed surface of the torque receiving portion 91, when the powder coating material is injected in the state in which the powder coating auxiliary tool 80 is accommodated in the recessed portion 6 of the caliper 1. Therefore, the film thickness of the powder coating material which adheres to the exposed surface of the torque receiving portion 91 can be formed to be gradually thinner toward a region in contact with the cover member 84.

<<Coating Device>>

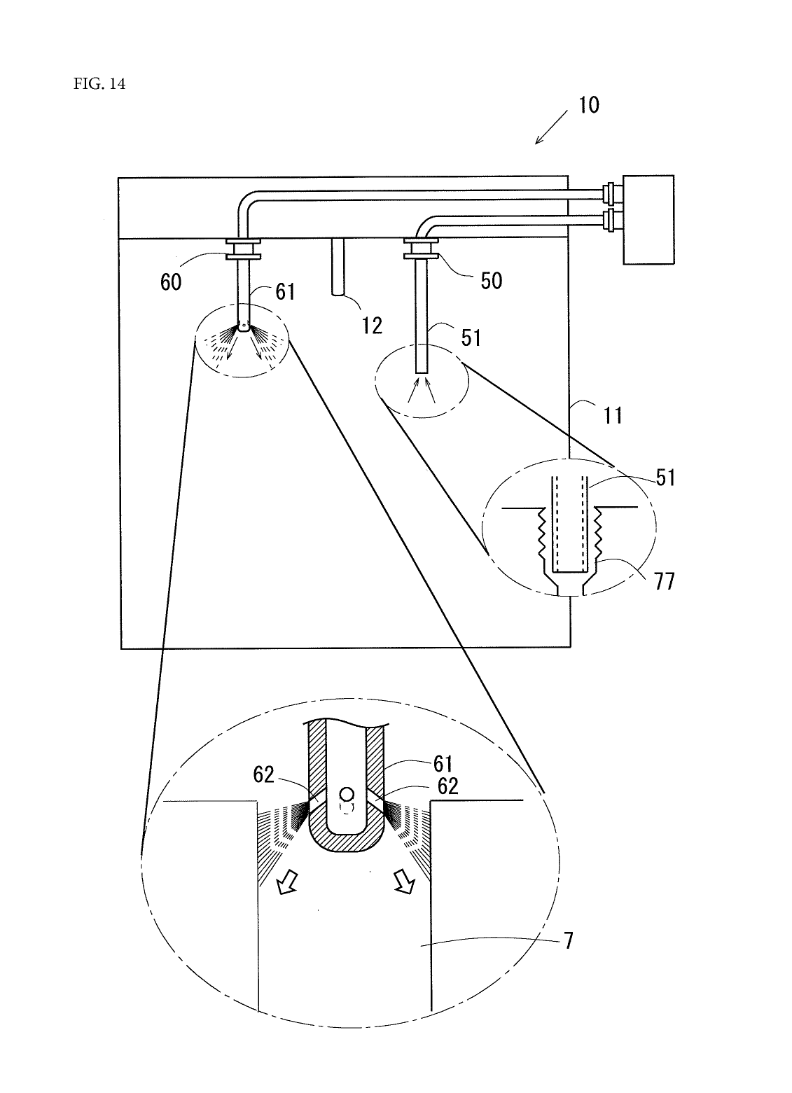

As illustrated in FIG. 7, the coating device 10 is installed within a movable range of the robot 70, and performs electrostatic coating of the caliper 1, and removal of coating on the region not needing coating, in the state in which the caliper 1 is grasped by the grasping portions 71 which are fixed to the tip end portion of the robot arm 73 of the robot 70. As illustrated in FIG. 14, the coating device 10 includes a coating nozzle 12 for an electrostatic coating material (a powder coating material) that is provided in a substantially center of a ceiling in a box 11, a suction device 50 and an ejection device 60 that are provided at a front side (a robot side) of the ceiling. The box 11 is opened at the front side, and the caliper 1 grasped by the robot 70 is capable of freely going in and out of the box 11. Note that the coating device 10 is provided with a dust collector (not illustrated) that sucks and collects the powder coating material in the box 11. The dust collector operates with suction strength that does not have an influence on coating at the time of coating, and sucks and collects the powder coating material in the box 11.

The coating nozzle 12 is connected to a tank that accommodates the powder coating material, a compressor and the like (not illustrated), and injects the electrified powder coating material downward. The coating nozzle 12 is electrically connected to the control device 40, and timing of injection of the powder coating material and an injection amount are controlled. The coating nozzle 12 is fixed to the ceiling of the box 11, and a whole of the caliper 1 is coated by three-dimensionally moving the robot arm 73 of the robot 70.

The suction device 50 sucks the powder coating material on the region not needing coating of the caliper 1 which is grasped by the grasping portions 71 which are fixed to the tip end portion of the robot arm 73 with a suction nozzle 51. An end portion of the suction nozzle 51 has a shape that is cut orthogonally to an axial direction of the nozzle. As the region not needing coating where the powder coating material is sucked by the suction device 50, the printed surface 8 of the caliper 1, bearing surfaces of the mounting holes 7, and the supply holes 77 are illustrated. For example, when the powder coating material in the supply hole 77 is sucked by the suction nozzle 51, a tip end of the suction nozzle 51 is inserted to a taper shoulder portion of the supply hole 77, and the powder coating material is sucked. The suction device 50 is electrically connected to the control device 40, and timing of suction and a suction force are controlled. The suction nozzle 51 is also fixed to the ceiling of the box 11, and sucks the powder coating material on the region not needing coating of the caliper 1 by moving the robot arm 73 three-dimensionally.

The ejection device 60 removes the powder coating material on the region not needing coating in the caliper 1 which is grasped by the grasping portions 71 which are fixed to the tip end portion of the robot arm 73 by ejection of air from an ejection nozzle 61. As the region not needing coating where the powder coating material is removed by the ejection device 60, the inner surface of the mounting hole 7 is illustrated. The ejection nozzle 61 according to the embodiment is provided with ejection ports 62 at sides in a nozzle tip end to be directed diagonally downward. As a result, when the ejection nozzle 61 is inserted into the mounting hole 7 and air is ejected, the powder coating material adhering to the inner surface of the mounting hole 7 is efficiently ejected outside, because the mounting hole 7 penetrates through the inside of the caliper 1. Note that an orientation of the ejection port 62 may be directed to a horizontal direction or diagonally upward instead of diagonally downward. The ejection device 60 is electrically connected to the control device 40, and timing for ejecting air and an ejection amount of air are controlled. The ejection nozzle 61 is fixed to the ceiling of the box 11, side by side with the suction nozzle 51, and removes the powder coating material on the region not needing coating of the caliper 1 by moving the robot arm 13 three-dimensionally.

<<Heating Device>>

As illustrated in FIG. 7, the heating device 20 is installed within the movable range of the robot 70, and applies heat to the caliper 1 after being coated and having the powder coating material in the region not needing coating removed, which is conveyed by the robot 70, and bakes the powder coating material onto the caliper 1. The heating device 20 is electrically connected to the control device 40, and a heating temperature and a heating time period are controlled.

<<Cooling Device>>

As illustrated in FIG. 7, the cooling device 30 is installed within the movable range of the robot 70, and cools the caliper 1 after heated, which is conveyed by the robot 70. The cooling device 30 is electrically connected to the control device 40, and a cooling temperature and a cooling time period are controlled.

<<Control Device>>

As illustrated in FIG. 7, the control device 40 is electrically connected to the robot 70, the coating device 10, the suction device 50, the ejection device 60, the heating device 20 and the cooling device 30, and controls these devices. More specifically, the control device 40 includes a CPU, a memory, an operation unit, a display unit and the like, and controls the respective devices by the CPU executing a control program stored in the memory.

<Coating Method>

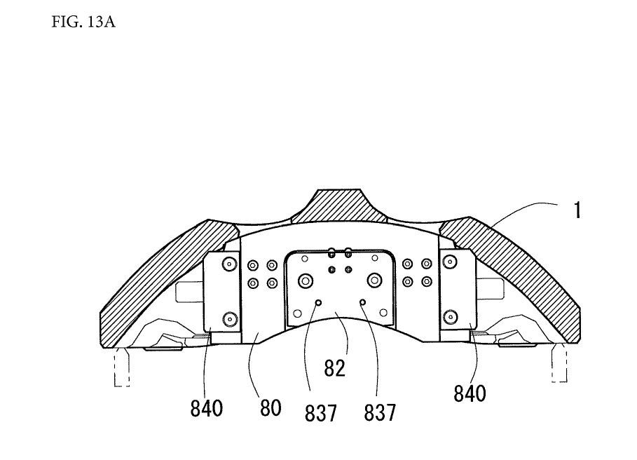

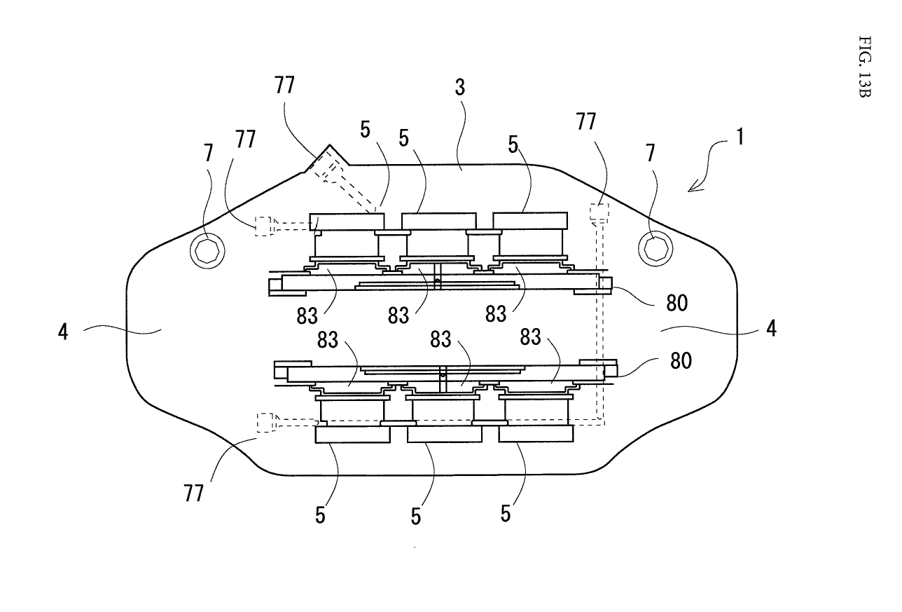

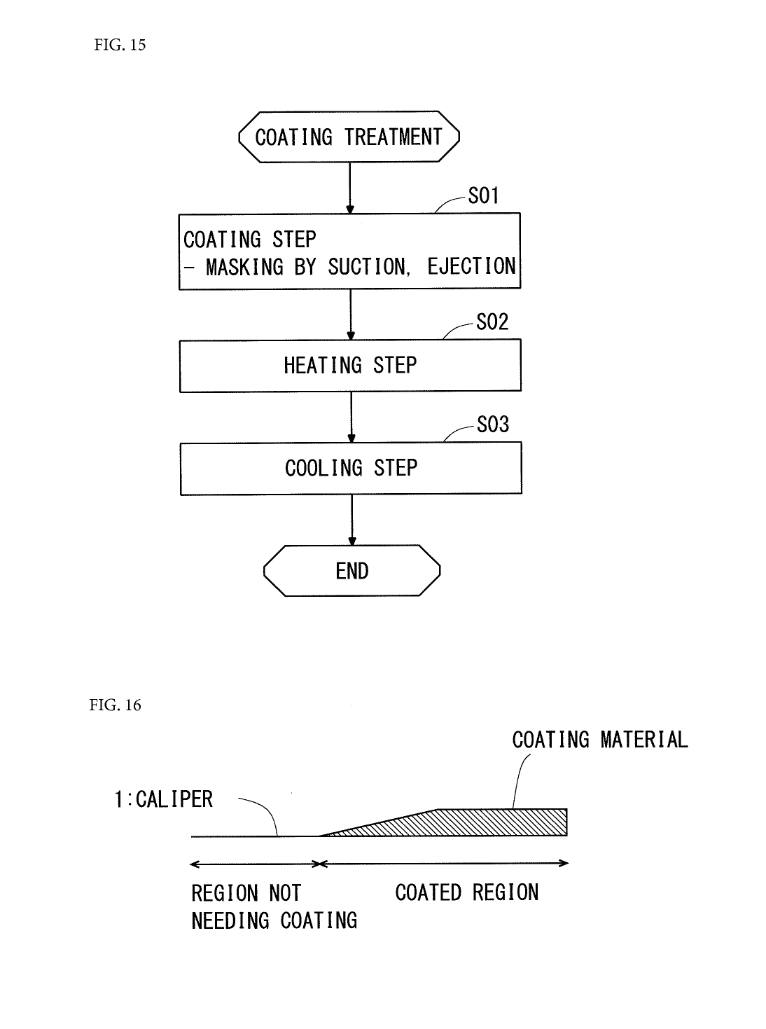

FIG. 15 illustrates a coating treatment flow according to the embodiment. Coating of the caliper 1 is started after conveyance of the cast caliper 1. In a coating step (step S01), coating of the caliper 1 and removal of the powder coating material in the region not needing coating are performed. More specifically, the robot 70 brings the distance between the powder coating auxiliary tools 80 which are fixed to the grasping portions 71 fixed to the tip end portion of the robot arm 73 to a distance that enables accommodation into the recessed portion 6, and causes the grasping portions 71 to advance into the recessed portion 6. Next, the robot 70 gradually enlarges the distance between the powder coating auxiliary tools 80, and fits the protruded portions 83 of the powder coating auxiliary tools into the cylinders 5 of the caliper 1 in a state in which airtightness is kept via the O-ring 834 (see FIG. 13B). As a result, the caliper 1 is grasped by the robot 70 in the state in which airtightness is kept. Next, the robot 70 moves the grasped caliper 1 to the coating device 10, and causes the caliper 1 to advance into the box 11. When the caliper 1 advances into the box 11, the coating nozzle 12 injects the electrified powder coating material. When the powder coating material is injected, the robot 70 three-dimensionally moves the grasped caliper 1 in the box 11. In response to injection of the powder coating material, the robot 70 supplied air into the air supply passage. As illustrated in FIG. 11, the supplied air passes through the air passage 836 and is ejected from the central outlet port 840 and the respective outlet ports 839. The air which is ejected from the central outlet port 840 passes through the other protruded portions 83 which communicate inside the caliper 1, and the supply holes 77 which communicate inside the caliper 1.

As a result, at the time of coating, adhesion of the powder coating material to the inner side surfaces of all the cylinders 5, the supply holes 77, the communication holes which allow the cylinders 5 to communicate with one another, and the communication holes which allow the cylinders 5 and the supply holes 77 to communicate with one another is restrained. Further, by the air which is ejected from the respective outlet ports 839, adhesion of the powder coating material to the inner surfaces of the clip mounting portions 9 in the recessed shapes is restrained. At this time, in the close vicinities of the respective outlet ports 839, adhesion of the powder coating material is restrained the most effectively, and the farther away from the respective outlet ports 839, the weaker the effect of restraining adhesion of the powder coating material becomes. Therefore, the film thickness of the powder coating material which adheres to the inner surface of the clip mounting portion 9 in the recessed shape becomes gradually thinner toward the inlet port side from the back side (see FIG. 16). As a result, the powder coating material which adheres to the inner surface of the clip mounting portion 9 in the recessed shape also becomes difficult to peel off. As above, by a positive pressure, adhesion of the powder coating material to the supply holes 77, and the clip mounting portions 9 is restrained. Further, the main body portion 81 is configured from a resin, and is non-conductive, and therefore, in the region in contact with the main body portion 81, of the recessed portion 6 of the caliper 1, adhesion of the powder coating material is restrained. Namely, irrespective of a positive pressure or a negative pressure, adhesion of the powder coating material is restrained. Further, in the case of the inclined portion 810 of the main body portion being formed at the edge of the outer side surface of the main body portion 81, when the powder coating material is injected in the state in which the powder coating auxiliary tool 80 is accommodated in the recessed portion 6 of the caliper 1, the powder coating material advances into the gap which is formed between the inclined portion 810 of the main body portion and the inner surface of the recessed portion 6 of the caliper 1. Therefore, the film thickness of the powder coating material which adheres to the inner surface of the recessed portion 6 of the caliper 1 can be formed to be gradually thinner toward the region which is in contact with the main body portion 81. Note that the exposed surface of the torque receiving portion 91 contacts the cover member 84 formed of an insulator, whereby adhesion of the powder coating material is restrained. Namely, adhesion of the powder coating material is restrained irrespective of a positive pressure or a negative pressure. Further, in the case of the inclined portion 840 of the cover member being formed at the edge of the outer side surface of the cover member 84 of an insulator, when the powder coating material is injected in the state in which the powder coating auxiliary tools 80 are accommodated in the recessed portion 6 of the caliper 1, the powder coating material advances into the gap which is formed between the inclined portion 840 of the cover member and the exposed surface of the torque receiving portion 91. Therefore, the film thickness of the powder coating material which adheres to the exposed surface of the torque receiving portion 91 can be formed to be gradually thinner toward the region which is in contact with the cover member 84.

Note that after start of injection of the powder coating material, the caliper 1 may be advanced into the box 11. When the three-dimensional movement in the box 11 which is programmed in advance is completed, the robot 70 moves the grasped caliper 1 to a close vicinity to the ejection nozzle 61.

Next, the robot 70 moves the grasped caliper 1 three-dimensionally so that the ejection nozzle 61 advances into the mounting hole 7. When the ejection nozzle 61 advances into the mounting hole 7, the ejection device 60 ejects air from the ejection nozzle 61, and removes the powder coating material adhering to the inner surface of the mounting hole 7. Namely, the powder coating material which adheres to the inner surface of the mounting hole 7 is removed by the positive pressure. The removed powder coating material is discharged from the opening portion (the inner side of the caliper 1) at a side opposite from the entry side of the ejection nozzle 61. When a plurality of mounting holes 7 are present, the robot 70 moves the grasped caliper 1 three-dimensionally, and causes the ejection nozzle 61 to advance into the mounting holes 7 in sequence. Next, the robot 70 moves the grasped caliper 1 to a close vicinity of the suction nozzle 51.

Next, the robot 70 moves the grasped caliper 1 three-dimensionally so that the end portion of the suction nozzle 51 is in a close vicinity to the region not needing coating. When the suction nozzle 51 approaches the region not needing coating, the suction device 50 starts suction by the suction nozzle 51, and removes the powder coating material adhering to the region not needing coating. Namely, the powder coating material is removed by the negative pressure. As the region not needing coating, the inner surface of the supply hole 77, the bearing surface of the mounting hole 7 and the printed surface 8 are illustrated. When a plurality of regions not needing coating are present, the robot 70 moves the grasped caliper 1 three-dimensionally, brings the suction nozzle 51 close to the regions not needing coating in sequence, and removes the powder coating material adhering to the regions not needing coating by suction. From the above, the coating step including masking is completed. By the above, the coating step including masking is completed. When the coating step is completed, the flow proceeds to a heating step.

In the heating step (step S02), the caliper 1 after electrostatic coating is baked. More specifically, the robot 70 moves the grasped caliper 1 to the heating device 20, and fixes the caliper 1 to a hanger of the heating device 20. When the caliper 1 is fixed to the hanger, the heating device 20 applies heat to the caliper 1 after electrostatic coating, and bakes the coating material to the caliper 1. When baking is completed, the robot 70 grasps the caliper 1 again. When the heating step is completed, the flow proceeds to a cooling step.

In the cooling step (step S03), the caliper 1 after heating is cooled. More specifically, the robot 70 moves the grasped caliper 1 after heating to the cooling device 30, and installs the caliper 1 in the cooling device 30. When the caliper 1 is accommodated in the cooling device 30, the cooling device 30 cools the caliper 1 after heating. When cooling is completed, the robot 70 grasps the caliper 1 again, and moves the caliper 1 to a conveyance place. By the above, electrostatic coating for the caliper 1 is completed. Thereafter, assembly of the brake pad, a piston, a clip C1 and the like to the caliper 1 is performed.

<Effect>

According to the powder coating system 100 according to the embodiment described above, the caliper 1 is grasped by the powder coating auxiliary tools 80 which are fixed to the grasping portions 71 that are fixed to the tip end portion of the robot arm 73 of the robot 70 which is movably three-dimensionally, and the caliper 1 can be moved three-dimensionally. Therefore, while the caliper 1 is being grasped by the robot arm 73, electrostatic coating, restraint of adhesion of the powder coating material to the region not needing coating, removal of the powder coating material adhering to the region not needing coating can be performed. Further, since the caliper 1 itself is movable three-dimensionally, the caliper 1 does not need to be fixed again, or a plurality of suction devices 50, ejection devices 60, and the like do not need to be disposed around the caliper 1, irrespective of the shape of the caliper 1. Therefore, restraint of adhesion of the powder coating material to the region not needing coating, and removal of the powder coating material adhering to the region not needing coating can be performed more easily than the conventional art. Further, since three-dimensional movement of the caliper 1 is freely performed, a difference of the film thickness of the coated part and the film thickness of the region not needing coating can be gradually decreased as illustrated in FIG. 16. In other words, the film thickness can be made gradually thinner from the coated part toward the region not needing coating. Therefore, occurrence of coating removal and the like which is feared in the conventional masking by a plug and a tape can be restrained.

Further, the caliper 1 includes the recessed portion and the cylinders 5, the powder coating auxiliary tool 80 is accommodated in the recessed portion 6 of the caliper 1, and the protruded portions 83 are fitted into the cylinders 5, whereby the recessed portion 6 of the caliper 1 can be supported stably from inside. Further, air is supplied via the air passage 836 of the powder coating auxiliary tool 80, and air is ejected from the central outlet port 840, whereby at the time of coating, adhesion of the powder coating material to the inner side surfaces of all the cylinders 5, the supply holes 77, the communication holes that cause the cylinders 5 to communicate with one another, and the communication holes that cause the cylinders 5 and the supply holes 77 to communicate with one another is restrained. Further, air is supplied via the air passage 836, and the air is ejected from the respective outlet ports 839, whereby adhesion of the powder coating material to the inner surfaces of the clip mounting portions 9 in the recessed shapes can be restrained. At this time, in the close vicinities of the respective outlet ports 839, adhesion of the powder coating material is restrained the most effectively, and the farther away from the respective outlet ports 839, the more weaker the effect of restraining adhesion of the powder coating material. Therefore, the film thickness of the powder coating material which adheres to the inner surface of the clip mounting portion 9 in the recessed shape becomes gradually thinner toward the inlet port side from the back side (see FIG. 16). As a result, the powder coating material which adheres to the inner surface of the clip mounting portion 9 in the recessed shape becomes difficult to peel off.

Meanwhile, in the region in contact with the main body portion 81, of the recessed portion 6 of the caliper 1, adhesion of the powder coating material is restrained. Namely, irrespective of a positive pressure or a negative pressure, adhesion of the powder coating material is restrained. Further, when the inclined portion 810 of the main body portion is formed at the edge of the outer side surface of the main body portion 81, the powder coating material advances into the gap which is formed between the inclined portion 810 of the main body portion and the inner surface of the recessed portion 6 of the caliper 1. Therefore, the film thickness of the powder coating material adhering to the inner surface of the recessed portion 6 of the caliper 1 can be formed to be gradually thinner toward the region which is in contact with the main body portion 81. Further, the exposed surface of the torque receiving portion 91 contacts the cover member 84 which is formed of an insulator, whereby adhesion of the powder coating material is restrained. Namely, irrespective of a positive pressure or a negative pressure, adhesion of the powder coating material is restrained. Furthermore, when the inclined portion 840 of the cover member is formed at the edge of the outer side surface of the cover member 84 of an insulator, the powder coating material advances into the gap which is formed between the inclined portion 840 of the cover member and the exposed surface of the torque receiving portion 91. Therefore, the film thickness of the powder coating material adhering to the exposed surface of the torque receiving portion 91 can be formed to be gradually thinner toward the region which is in contact with the cover member 84. Like this, in the powder coating system 100 according to the embodiment, the insulator is brought into contact with the region not needing coating irrespective of a positive pressure, a negative pressure, or a positive pressure and a negative pressure, depending on the region, whereby restraint of adhesion of the powder coating material to the region not needing coating, and removal of the powder coating material adhering to the region not needing coating can be performed.

Note that various contents described above can be combined wherever possible within the range not departing from the technical idea of the present invention.

For example, in the powder coating auxiliary tool 80, the shapes, the number and the like of the protruded portions 83 can be properly changed in accordance with the caliper 1. The shapes and the number of the protruded portions 83 can be changed in accordance with the number of cylinders of the caliper 1 which is a coating target. For example, in the case of a so-called first type disk brake in which cylinders are present at the inner side, in the powder coating auxiliary tool 80, the protruded portions 83 are provided at the inner side, and the outer side can be formed into a planar shape. The powder coating auxiliary tool 80 also can be favorably used in other cast products to which coating is applied in optional colors.

Further, the coating device 10, the heating device 20 and the cooling device 30 can be within the movable range of the robot 70, and the disposition locations, the disposition sequence and the like can be properly changed. Further, pluralities of robots 70, coating devices 10, heating devices 20 and cooling devices 30 may be installed.

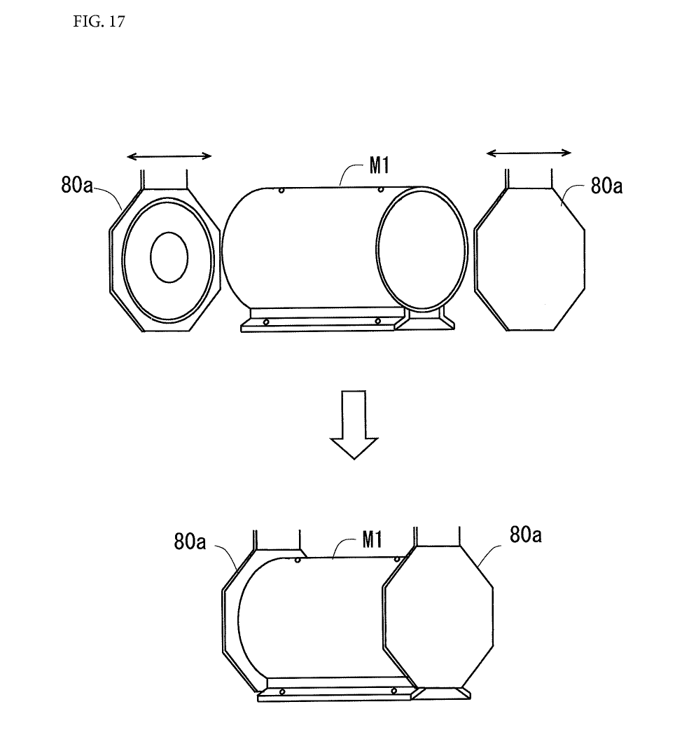

Further, the powder coating system 100 also can be used in other industrial products without being limited to a caliper by properly changing the shape and the size of the powder coating auxiliary tools 80. FIG. 17 illustrates a manner of grasping a motor case as the industrial product. A motor case M1 is in a cylindrical shape, can accommodate a motor inside, and includes cable holes that penetrate through an inside, in an upper part. Powder coating auxiliary portions 80a in plate shapes (hexagonal shapes in FIG. 17) having areas to cover two opening end portions of the motor case M1 like this are attached to an arm tip end of the robot 70, the motor case M1 is grasped in a state in which airtightness inside the motor case M1 is kept, and the inside is brought into a positive pressure, whereby adhesion of the powder coating material to the cable holes can be restrained.

### REFERENCE SIGNS LIST

1 . . . Caliper
2 . . . First body section
3 . . . Second body section
4 . . . Connecting section
5 . . . Cylinder
6 . . . Recessed section
7 . . . Mounting hole
9 . . . Clip mounting section
10 . . . Coating device
11 . . . Box
12 . . . Coating nozzle
20 . . . Heating device
30 . . . Cooling device
40 . . . Control device
50 . . . Suction device
51 . . . Suction nozzle
70 . . . Robot
73 . . . Robot arm
71 . . . Grasping section
77 . . . Supply hole
80 . . . Powder coating auxiliary tool
81 . . . Main body section
83 . . . Protruded section
84 . . . Cover member
91 . . . Torque receiving section
C1 . . . Pad clip
836 . . . Air Passage

1. A support tool that is used in a powder coating system that electrostatically attaches powder to a workpiece, is fixed to a robot arm, and supports the workpiece, wherein in the support tool, a region that is in contact with a part of a region not needing powder in the workpiece is formed of an insulator, and restrains adhesion of the powder to the part of the region not needing powder in the workpiece.

2. The support tool according to claim 1,
wherein the workpiece includes an opening portion, and a recessed portion that communicates with the opening portion; and
the support tool supports the recessed portion of the workpiece from inside, and includes an air passage in which air flows, in an inside.

3. The support tool according to claim 2,
wherein the support tool includes a fitting portion that is fitted in a part of the recessed portion of the workpiece in an airtight state,
the fitting portion is configured by a conductive member and is electrically grounded, and
powder is electrostatically attached to the workpiece in an electrically grounded state.

4. The support tool according to claim 1, wherein the support tool includes an inclined portion that gradually makes a thickness of the powder which adheres to the workpiece thinner toward the region not needing powder, at an edge portion of a surface that is in contact with the workpiece.

5. The support tool according to claim 1, wherein the workpiece includes a dent portion that is further dented from the recessed portion, in the recessed portion of the workpiece, and the support tool includes a protrudingly provided portion that enters the dent portion, and includes an outlet port that ejects air that restrains adhesion of powder to an inner surface of the dent portion.

6. A powder coating system that electrostatically attaches powder to a workpiece, comprising:
a support tool that supports the workpiece; and
a movable robot arm to which the support tool is fixed,
wherein in the support tool, a region that is in contact with a part of a region not needing powder in the workpiece is formed of an insulator, and restrains adhesion of the powder to the part of the region not needing powder of the workpiece.

7. The powder coating system according to claim 6, further comprising: a removing device that restrains adhesion of powder to the region not needing powder in the workpiece which is supported by the support tool at a tip end portion of the robot arm, or removes powder that adheres to a powder adhering region, by at least either one of ejection or suction.

8. The powder coating system according to claim 7,
wherein the removing device comprises at least any one of
a first ejection device that restrains adhesion of powder to the region not needing powder, by ejection of air,
a second ejection device that removes powder adhering to the region not needing powder, by ejection of air, and
a suction device that removes the powder adhering to the region not needing powder, by suction.

9. The powder coating system according to claim 7,
wherein the removing device includes a first ejection device that restrains adhesion of the powder to the region not needing powder, by ejection of air,
the workpiece includes an opening portion, and a recessed portion that communicates with the opening portion,
the support tool supports the recessed portion of the workpiece from inside, and includes an air passage in which air flows in an inside, and
the first ejection device ejects air via the air passage of the support tool, and restrains adhesion of powder to an inner surface of the opening portion, from inside of the workpiece.

10. The powder coating system according to claim 6,
wherein the removing device includes a second ejection device that removes the powder adhering to the region not needing powder, by ejection of air, and
the second ejection device inserts an ejection nozzle into an opening portion of the workpiece, ejects air, and removes powder adhering to an inner surface of the opening portion of the workpiece.

11. The powder coating system according to claim 6,
wherein the support tool includes a fitting portion that is fitted in a part of a recessed portion of the workpiece in an airtight state,
the fitting portion is configured by a conductive member, and is electrically grounded, and
powder is electrostatically attached to the workpiece in an electrically grounded state.

12. The powder coating system according to claim 6, wherein the workpiece is a caliper for a brake, a cylinder is provided in a part of the recessed portion of the workpiece, and a part of the region not needing powder is a pad clip mounting portion and a torque receiving portion.

13. A powder coating method that electrostatically attaches powder to a workpiece, comprising the step of: supporting the workpiece by a support tool that is fixed to a tip end portion of a movable robot arm, and restraining adhesion of powder to a part of a region not needing powder of the workpiece, by making a region that is in contact with the part of the region not needing powder in the workpiece, of the support tool, an insulator.

14. The powder coating method according to claim 13, further comprising:
a powder removing step of restraining adhesion of powder to the region not needing powder in the workpiece supported by the support tool fixed to the tip end portion of the robot arm, or removing powder adhering to a powder adhering region, by at least either one of ejection or suction.

15. The powder coating method according to claim 14, further comprising:
a powder coating step of attaching powder to the workpiece; and
a heating step of heating the workpiece to which the powder adheres.

16. A caliper that is produced by the powder coating system according to claim 6.

17. The caliper according to claim 16, wherein the caliper is formed so that a film thickness is gradually thinner toward a region not needing powder from a powder adhering region.
